(19) United States
(12) Patent Application Publication
(10) Pub. No.: US 2016/0180371 A1
(43) Pub. Date: Jun. 23, 2016

(54) Apparatus and Method to Attract Potential Customers to a Dual Screen Coupon Kiosk

(71) Applicant: Lawson Deng, San Jose, CA (US)

(72) Inventor: Lawson Deng, San Jose, CA (US)

(21) Appl. No.: 15/058,145

(22) Filed: Mar. 1, 2016

Related U.S. Application Data
(63) Continuation-in-part of application No. 13/606,053, filed on Sep. 7, 2012.

(51) Int. Cl. G06Q 30/02; G06Q 20/18; G06Q 20/10; G06Q 90/00

(52) U.S. Cl. CPC G06Q 30/0237; G06Q 90/20; G06Q 30/0235; G06Q 20/18; G06Q 20/10; G06Q 30/0224

(57) ABSTRACT

The dual screen coupon kiosk is an apparatus that attracts potential customers with a prominent display and provides the potential customers with an easy-to-use interface. The dual screen coupon kiosk comprises a touch screen, a card reader, a gift certificate scanner, a printer, a keypad, and a user login receiver. The card reader and the gift certificate scanner retrieve financial information from a user. The printer allows the apparatus to physically print a specific coupon for a user. The keypad or the user login receiver allows access to a specific user account. The software running on the apparatus attracts potential customers by displaying either an advertisement or a map of the shopping area on the top portion of the touch screen. The software provides the interface to browse the coupons through the bottom portion of the touch screen. The software primarily organizes the coupons either by categories or by merchant.

The current application is a continuation-in-part (CIP) application of the U.S. non-provisional application Ser. No. 13/606,053 filed on Sep. 7, 2012.

### FIELD OF THE INVENTION

The present invention relates generally to a kiosk capable of attracting potential customers in order to dispense coupons to those customers. More specifically, the present invention uses a dual screen configuration to have separate displays for attracting customers and for allowing customers to browse through the coupons.

### BACKGROUND OF THE INVENTION

Traditionally, coupons are available to potential customers through a variety of outlets such as print media, advertisements, leaflets, and websites. These outlets provide coupons in a disorganized manner and are usually not located in proximity to the stores being promoted by the coupons. In addition, the coupons from a particular outlet rarely match the shopping interests of the person viewing the particular outlet. However, the present invention is a kiosk apparatus that consolidates access to many coupons and can be located in proximity to heavy traffic shopping area such as shopping malls or shopping markets. On the top section of the dual screen coupon kiosk, the present invention attracts potential customers to kiosk by displaying either prominent digital advertisements or a map of the shopping area. On the bottom section of the dual screen coupon kiosk, the present invention provides potential customers with an easy-to-use interface to efficiently browse through the coupons in order to find a particular coupon that matches a customer's interests.

### BRIEF DESCRIPTION OF THE DRAWINGS

FIG. 1 is a front perspective view of the dual screen coupon kiosk.

FIG. 2 is a front view of the dual screen coupon kiosk.

FIG. 3 is a back perspective view of the dual screen coupon kiosk.

FIG. 4 is a simplified electronic schematic of the dual screen coupon kiosk and the user login card.

FIG. 5 is a perspective view of the user login card.

FIG. 6A is a flowchart describing the overall process of the first embodiment of the software application.

FIG. 6B is a continuation of the flowchart describing the overall process of the first embodiment of the software application.

FIG. 7A is a flowchart describing the overall process of the second embodiment of the software application.

FIG. 7B is a continuation of the flowchart describing the overall process of the second embodiment of the software application.

FIG. 7c is a continuation of the flowchart describing the overall process of the second embodiment of the software application.

FIG. 8 is a flowchart describing the process of arranging coupons by categories.

FIG. 9 is a flowchart describing the process of arranging coupons by merchants.

FIG. 10 is a flowchart describing the process of arranging coupons by their popularity.

FIG. 11 is a flowchart describing the unique applications that are available to a user after logging on the software application with a user account.

FIG. 12 is a flowchart describing the process of viewing the subscription coupons for a specific user account.

FIG. 13 is a flowchart describing the process of purchasing gift certificates or purchasable coupons.

FIG. 14 is a flowchart describing the process of purchasing group coupons.

### DETAILED DESCRIPTIONS OF THE INVENTION

All illustrations of the drawings are for the purpose of describing selected versions of the present invention and are not intended to limit the scope of the present invention.

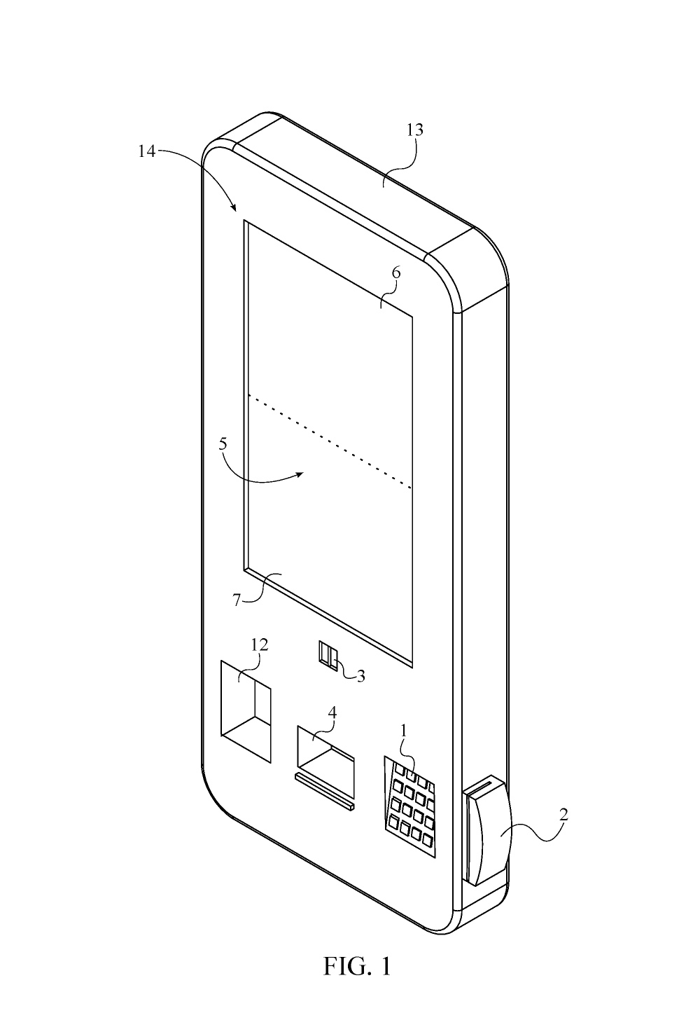

As can be seen in FIG. 1, the present invention is a dual screen coupon kiosk, which is used to attract customers passing by the present invention with advertisements on one display screen. The dual screen coupon kiosk is also used to browse and distribute coupons to those customers through the other display screen. The present invention is designed to be wall-mounted apparatus that can be placed within a heavy traffic retail shopping area such as shopping malls, shopping markets, or department stores. The present invention mainly comprises a keypad 1, a card reader 2, a user login receiver 3, a gift certificate scanner 4, a touch screen 5, a pre-programmed computer 8, an internet-access module 9, a printing paper roll 10, a printer 11, a printer output box 12, an enclosure 13, and a user login card 16, which are shown in FIGS. 1, 3, 4, and 5. The enclosure 13 is used to house the other components of the present invention and provides a structure for the present invention. The touch screen 5 allows a user of the present invention to interact with the software running on the pre-programmed computer 8. The touch screen 5 comprises a top section 6 and a bottom section 7, and the software manages how advertisements and coupons are displayed on the top section 6 and the bottom section 7. The keypad 1 allows the user to access their specific user account by allowing the user to input a unique identification code such as their phone number, their user account password, the verification code and/or zip code for credit card, or the pin code for debt card transactions. The user login card 16 and the user login receiver 3 also allow the user to access the specific user account by allowing the user to swipe and scan the user login card 16 on the user login receiver 3 in order to retrieve their unique identification code. The printing paper roll 10, the printer 11, the printer output box 12 are all used to physically print coupons from the present invention. The gift certificate scanner 4 allows the software running on the pre-programmed computer 8 to retrieve the financial funds that are stored on a gift certificate. In addition, the card reader 2 allows the software running on the pre-programmed computer 8 to retrieve the financial funds that are available through a credit card or a debit card. Finally, the internet-access module 9 allows the pre-programmed computer 8 to communicate with a network of other computers such as the Internet in order to receive or send different kinds of information. More specifically, the internet-access module 9 allows the software running of the pre-programmed computer 8 to communicate with and access information on a server or central system.

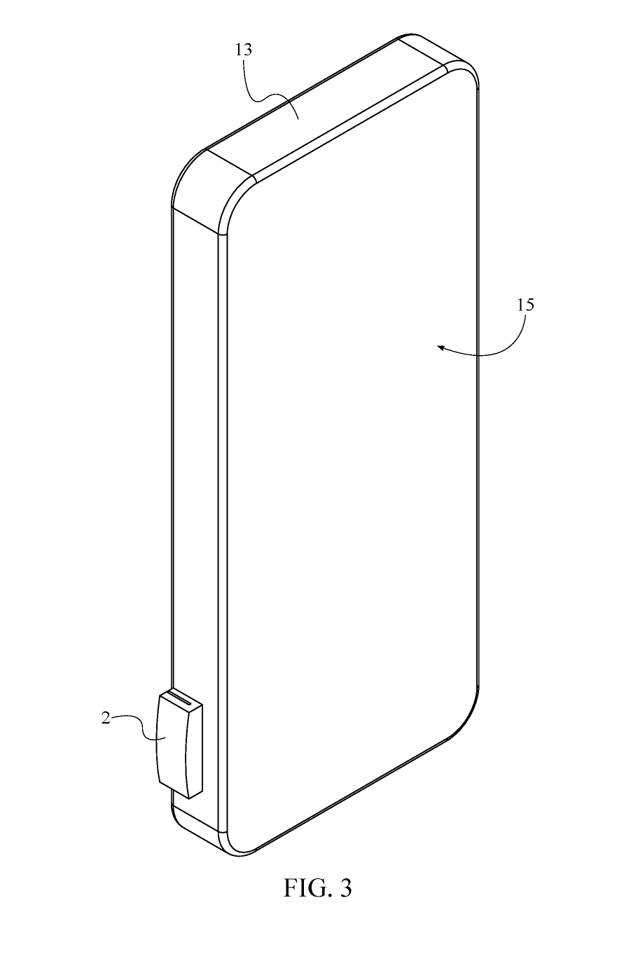

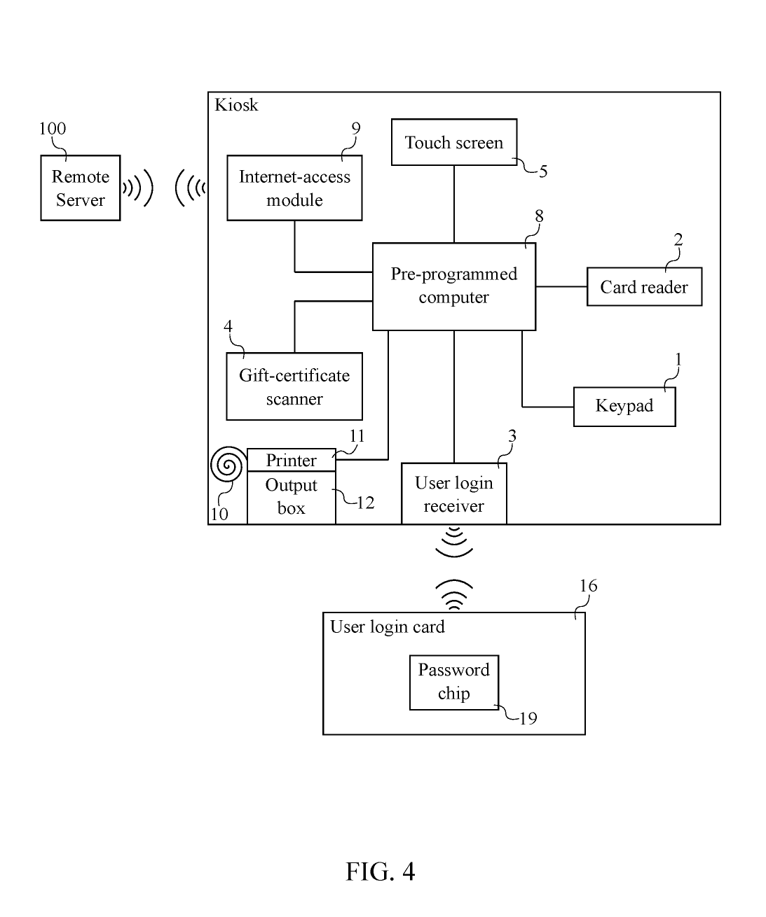

The other components of the present invention are configured in relation to the enclosure 13. As can be seen in FIGS. 1 and 3, the enclosure 13 comprises a transparent portion 14, which allows the user to see the touch screen 5 through the enclosure 13, and a wall mounting portion 15, which allows the present invention to be properly mounted to a vertical wall. The transparent portion 14 and the wall mounting portion 15 are positioned on the enclosure 13 opposite to each other. The touch screen 5, the pre-programmed computer 8, the internet-access module 9, the printing paper roll 10, the printer 11, and the printer output box 12 are located within the enclosure 13, which is illustrated in FIG. 4, and are protected by the enclosure 13 from different kinds of damage. The touch screen 5 is positioned adjacent to the transparent portion 14 so that the user can see and interact with the touch screen 5 through the enclosure 13. The transparent portion 14 also prevents damage to the touch screen 5 from continuous touching by customers passing by the present invention. Also within the enclosure 13, the printing paper roll 10 is rotatably connected to the enclosure 13, which allows the printer 11 to unroll a segment of printing paper roll 10 in order to physically print a coupon. The printing paper roll 10 needs to be inserted into the printer 11 so that the printer 11 can pull the segment off from the printing paper roll 10. The printer 11 is positioned above the printer output box 12 and is used to physically print the coupon, which allows the segment to fall into the printer output box 12 once the printer 11 has finished printing the coupon.

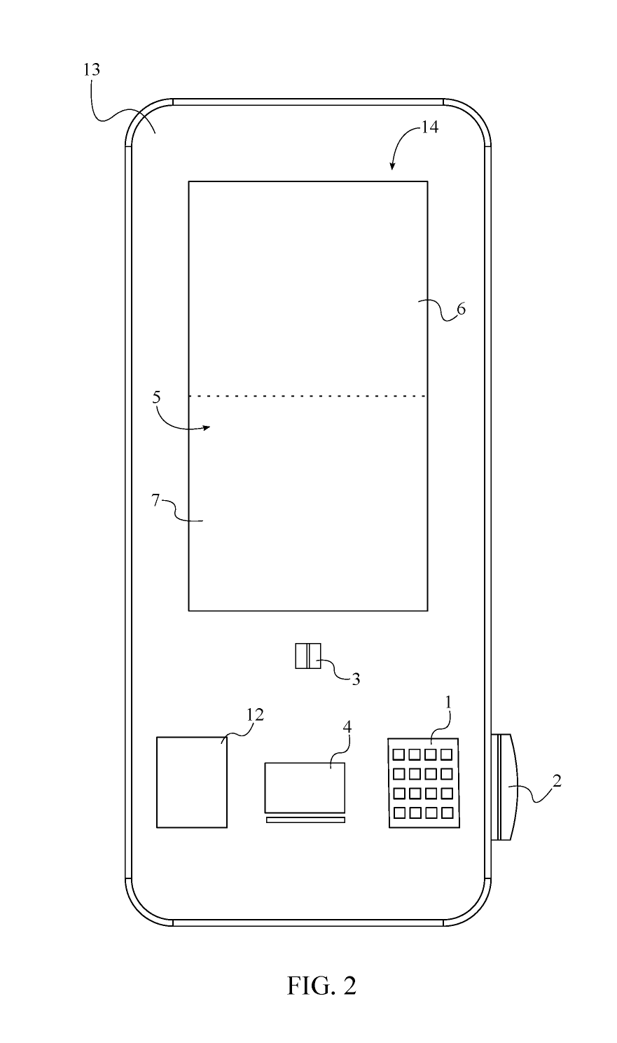

As can be seen in FIG. 2, some components of the present invention are configured on the enclosure 13 to make the present invention easier to use. For example, the user login receiver 3, the printer output box 12, the gift certificate scanner 4, and the keypad 1 are positioned coplanar to the transparent portion 14, which forms an easy-to-use control panel near the visual display of the touch screen 5. The user login receiver 3 is centrally positioned on the enclosure 13 adjacent to the transparent portion 14 so that a customer with a user login card 16 to easily find the user login receiver 3 on the present invention and to access their personal user account. The printer output box 12, the gift certificate scanner 4, and the keypad 1 are positioned adjacent to user login receiver 3 opposite to the transparent portion 14. The printer output box 12 also traverses through the enclosure 13 so that the user can reach into the printer output box 12 and through the enclosure 13 in order to grab the printed coupon. The gift certificate scanner 4 and the keypad 1 are connected to the enclosure 13, which stabilizes the gift certificate scanner 4 and the keypad 1 on the enclosure 13 as they are being used. The card reader 2 is laterally connected onto the enclosure 13 in between the transparent portion 14 and the wall mounting portion 15 so that the front of the present invention is not cluttered by too many components.

As can be seen in FIG. 4, the input/output components of the present invention are coupled to the pre-programmed computer 8 so that the software can effectively retrieve and send the signals to the input/output components. As input components, the keypad 1 and the user login receiver 3 is electronically connected to the pre-programmed computer 8 as a means to retrieve the unique identification code that corresponds to a specific user account. Also as input components, the card reader 2 and the gift certificate scanner 4 are electronically connect to the pre-programmed computer 8 as a means to retrieve financial information from the user. For the output components, the electronic connection between the top section 6 of the touch screen 5 and the pre-programmed computer 8 is separate from the electronic connection between the bottom section 7 of the touch screen 5 and the pre-programmed computer 8 because the top section 6 and bottom section 7 will show separate visual displays. In another embodiment of the present invention, the touch screen 5 is electronically connected to the pre-programmed computer 8 through one single electronic connection, and the software application separates the touch screen 5 into a top portion 6 and a bottom portion 7. Also as an output component, the printer 11 is electronically connected to the pre-programmed computer 8 as a means to physically print a coupon onto a segment of printing paper roll 10.

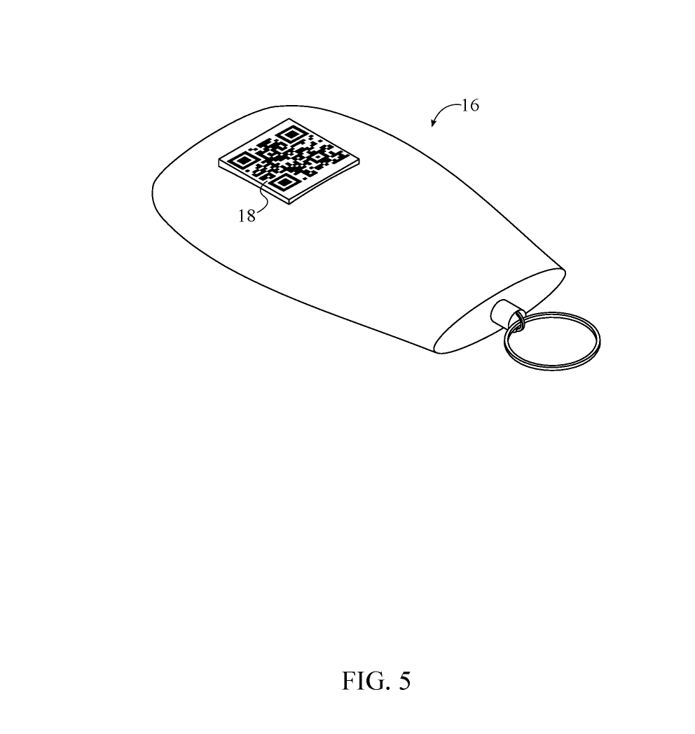

As can be seen in FIGS. 4 and 5, the user login card 16 is a separate component from the kiosk portion of the present invention. Each user can have a user login card 16 to access their specific user account on the software and access the information associated with their specific user account. The user login card 16 comprises a cover 17, a printed two-dimensional code 18, and a password smart chip 19. The password smart chip 19 is located within the cover 17, which protects the password smart chip 19 from getting damaged. In the preferred embodiment of the present invention, the user login card 16 is attached to a user's key chain and, thus, the cover 17 prevents damage from the user's keys to the password smart chip 19. The printed two-dimensional code 18 is positioned on the cover 17. When the user swipes the user login card 16 onto the user login receiver 3, the scanner portion of the user login receiver 3 scans the two-dimensional code 18 in order to retrieve an unique identification code, which the present invention will match to a specific user account. In addition, the sensor portion of the user login receiver 3 will verify the unique identification code with the password smart chip 19 in order to authenticate the identity of the user and their user login card 16. However, the user can still enter their phone number as their unique identification code through the keypad 1.

The software running on the pre-programmed computer 8 is a process that allows a user to navigate through a dual-screen coupon-dispensing interface by executing computer-executable instructions stored on a non-transitory computer-readable medium. The software must be provided with a touch screen 5 that has a separate top section 6 and a separate bottom section 7. The software must also be provided with a plurality of coupons, which can be retrieved from an at least one remote server or a central system 100. The remote server 100 acts a hub to manage the necessary information required to run the software on a multitude of the present invention. Retailers can upload their coupons onto the server or central system through a management interface. Each of the coupons includes, but is not limited to, merchant information, product/service information, auxiliary coupon information, print history, and a two-dimensional bar code. The merchant information is a detailed description of the merchant that is promoting the coupon. The product/service information is a detailed description of the product/service that is being promoted by the coupon. The auxiliary coupon information is the kind of information that is commonly found on every coupon such as an expiration date and by how much the product/service is being discounted. The two-dimensional bar code allows the user to retrieve a coupon from the software with their mobile computing device without having to physically connect their device to the kiosk portion of the present invention. In general, the information contained by a coupon can be categorized in any manner, but, for the present invention, the information contained by each coupon is categorized into merchant information, product/service information, auxiliary coupon information, print history, and the two-dimensional bar code as a means to describe the sorting function of the software.

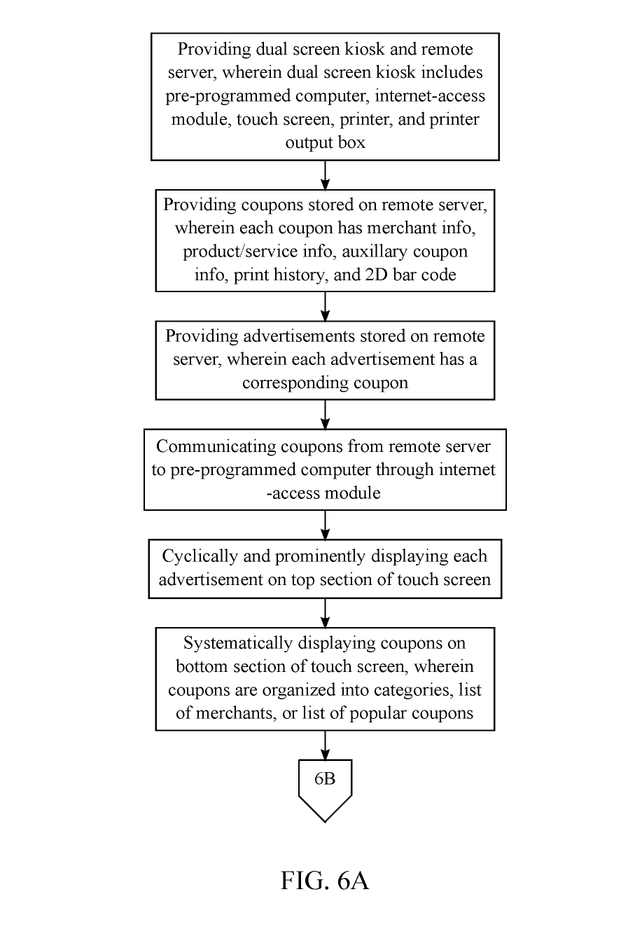

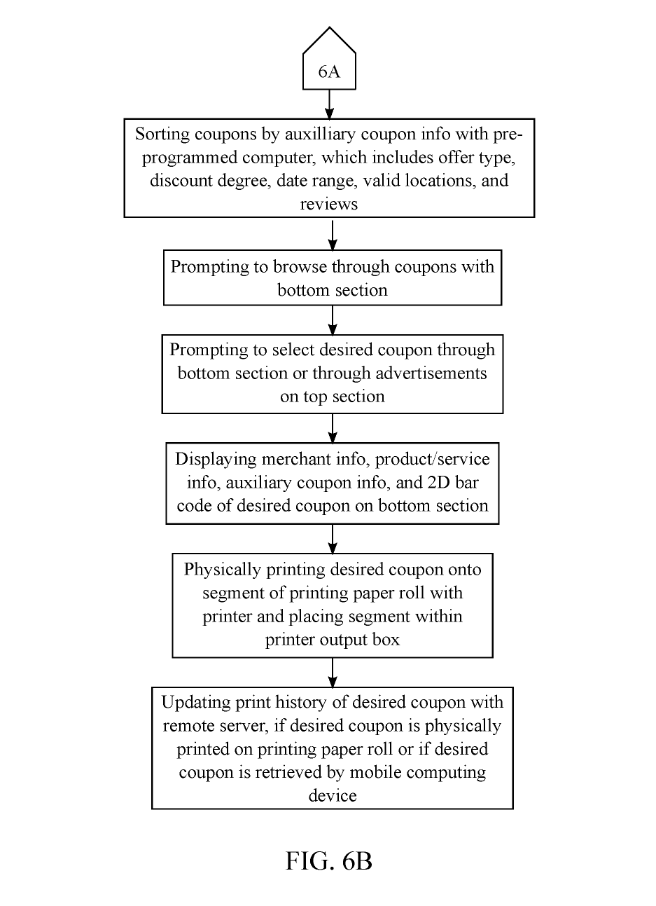

The software begins by showing a visual display on the top section 6 of the touch screen 5 in order to attract customers that are passing by the present invention. In the first embodiment of the present invention, the software is provided a plurality of advertisements, which are used to lure customers towards the kiosk and to interact with the software. The plurality of advertisements is stored on the pre-programmed computer 8. The process of the first embodiment is shown in FIGS. 6A and 6B. The plurality of advertisements should be vibrant in color and should be large enough so that each of the plurality of advertisements can be seen by the customers at a far distance. The software will prominently display the plurality of advertisements one at a time on the top section 6 of the touch screen 5 and will cycle through all of the plurality of advertisements. In addition, each of the plurality of advertisements is associated to a corresponding coupon from the plurality of coupons, which allows a user to obtain a physical copy of the promotional content shown in each of the plurality of advertisements.

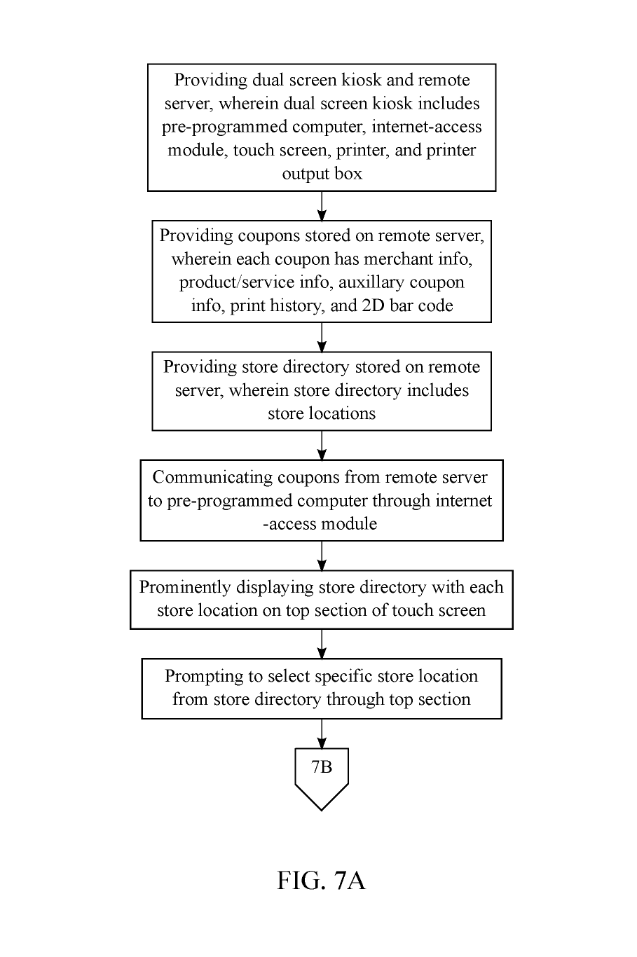

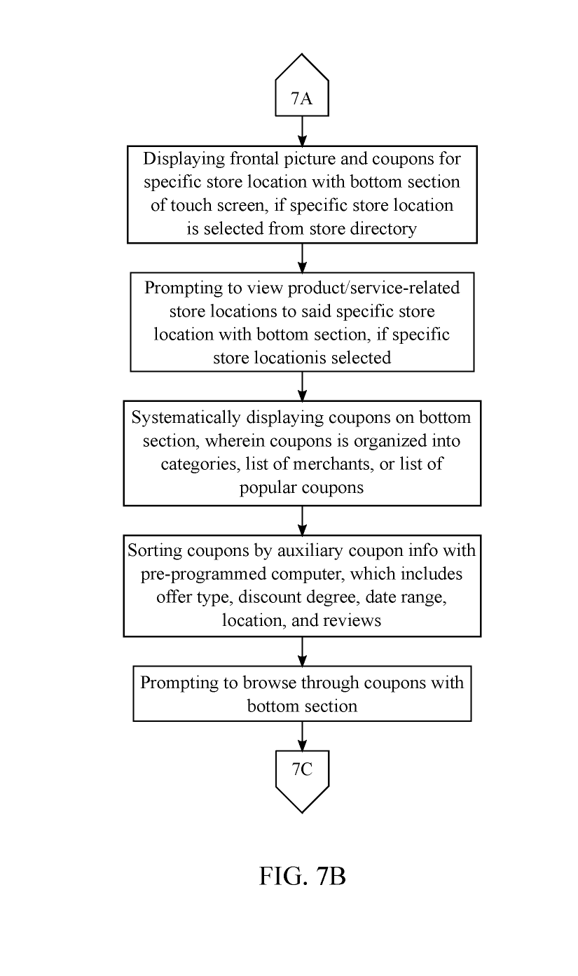

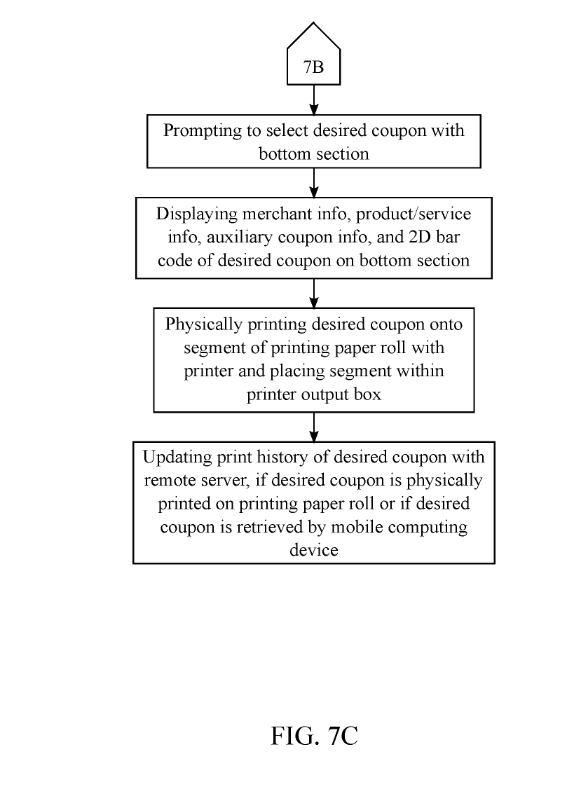

In the second embodiment of the present invention where the kiosk is located in a heavy traffic shopping area, the software is provided with a store directory that includes a plurality of store locations, which are used to lure customers towards the kiosk and to interact with the software. The store directory is stored on the remote server 100 so that the store directory can be accessed by a multitude of dual screen kiosks. Consequently, the store directory needs to be communicated from the remote server 100 to the pre-programmed computer 8 through the internet-access module 9. The process of the second embodiment is shown in FIGS. 7A, 7B, and 7C. The store directory should also be vibrant in color and should be easy to understand and easy to follow for the customers. The software will prominently display the store directory with each of the plurality of store locations on the top section 6 so that customers passing by the kiosk will be able to readily identify the store directory as a means to get location information about the shopping area. The software will continue by prompting the user to select a specific store location from the store directory with the top section 6. The specific store location is any store on the store directory that the user would like to receive more information. Once the user selects the specific store location with the top section 6 of the touch screen 5, the software will display a frontal picture of the specific store location and the coupons associated with that specific store on the bottom section 7 of the touch screen 5. The frontal picture allows the user to see the appearance of that specific store and allows the user to more easily look for and locate that specific store. The software will also prompt the user to view related store locations to the specific store location with the bottom section 7 and to view the coupons that are associated with those similar store locations. The related store locations are stores that offer similar products/services as the specific store location. Displaying the related store locations alongside the specific store location improves the marketing functionality of the software.

In an alternate configuration of the second embodiment, the software could additionally prompt the user to view the other store locations, which are adjacent to that specific store location. The software will prompt the user by display arrows on both sides of the frontal picture of that specific store location. The arrow positioned on the left side of the frontal picture will redirect the user to the frontal picture of the store located on the left side along with the associated coupons for that store on the left side. Similarly, the arrow position on the right side of the frontal picture will redirect the user to the frontal picture of the store located on the right side along with the associated coupons for that store on the right side.

In both the first embodiment and the second embodiment, the remote server 100 communicates the plurality of coupons to the pre-programmed computer 8 through the internet-access module 9 so that the plurality of coupons can be accessed from the remote server 100 by a multitude of dual screen kiosks. The overall process of the software will begin by systematically displaying the plurality of coupons of the bottom section 7. In order to increase the efficiency of viewing the plurality of coupons, the software can organize the plurality of coupons into a plurality of categories, a list of merchants, or a list of popular coupons with the pre-programmed computer 8. The list of popular coupons is determined by comparing the print-through rate of each of the plurality of coupons and by sorting from. The print-through rate for a coupon is calculated from the coupon's print history with the remote server 100 and is the frequency that the coupon has been physically printed or retrieved by a mobile computing device within a period of time. For example, a coupon that has been printed or retrieved four times within a week will have a higher print-through rate than a coupon that has been printed or retrieved four times within a month. Also to increase the efficiency of viewing the plurality of coupons, the software will further sort the plurality of coupons by their auxiliary coupon information, which includes offer type, discount degree, date range, valid locations, and reviews. The offer type describes how the coupon is discounting the product/service. The discount degree is the ratio between the cost of the product/service at the full price and the cost of the product/service at the discount price. For example, a grocery store sells one apple at $2.00, and the offer type for a store coupon is “buy two and get one free”. The discount degree would be the ratio between buying three apples at full price with $6.00 and buying three apples at $4.00 with the store coupon. For another example, a department store sells a shirt at $50.00, and the offer type for a store coupon is “Spend $50.00 and get $20.00 off.” In this case, the discount degree would be the ratio between buying the shirt at full price with $50.00 and buying the shirt at $30.00 with the store coupon. For a third example, an electronic store sell a television at $700.00, and the offer type for a store coupon is “Spend more than $600.00 and get 10% off”. In this case, the discount degree would be the ration between buying the television at full price with $700.00 and buying the television at $630.00 with the store coupon. The date range is the time period that the coupon remains valid. For example, the date range for a coupon could be between the time when the user obtained the coupon and the expiration date of the coupon. Also for example, the date range for a coupon could be the time elapsing a holiday weekend. The valid locations are which stores or what areas that the coupon is valid. For example, the valid locations could restrict a coupon from being accepted anywhere except specific states or specific store locations. The rating is a grade given by other customers that have used the coupon and is based on the value of the perceived coupon by the consumers and the quality of customer's experience while using the coupon.

The organization of the plurality of coupons allows the software to prompt the user to browse through the plurality of coupons by using the bottom section 7 of the touch screen 5. As the user is browsing through the plurality of coupons, the software will prompt the user to select a desired coupon from the plurality of coupons with the bottom section 7 of the touch screen 5. In the first embodiment of the present invention as opposed to the second embodiment, the software also allows the user to select a desired coupon through the plurality of advertisements shown on the top section 6 of the touch screen 5 because each advertisement has a corresponding coupon within the plurality of coupons. Once the desired coupon is selected by the user, the software will then display the merchant information, the product/service information, the auxiliary coupon information, and the two-dimensional bar code of the desired coupon to the bottom section 7 of the touch screen 5 so that the user can view all of the details for the desired coupon. The two-dimensional bar code is specifically displayed by the software so that the user can retrieve the desired coupon with their mobile computing device such as a smart-phone or a tablet personal computer. The mobile computing device can retrieve the desired coupon by either taking a picture of the two-dimensional bar code or scanning the two-dimensional bar code. The software will also be able to physically print the desired coupon onto a segment of the printing paper roll 10 with the printer 11 and be able to place the segment within the printer output box 12. Once the desired coupon is either physically printed onto a segment of printing paper roll 10 or retrieved by a mobile computing device, the software will then update the print history of the desired coupon on the remote server 100.

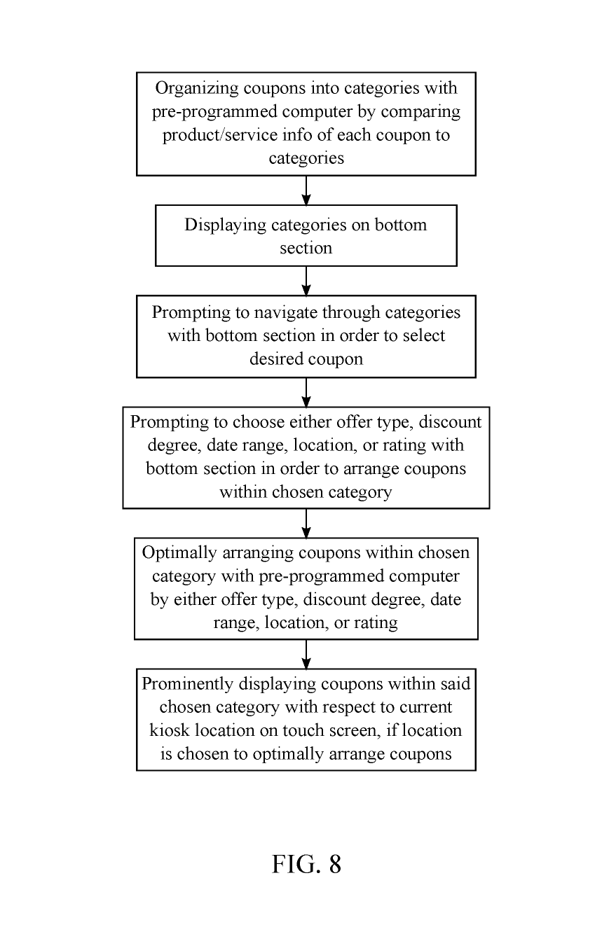

For the bottom section 7 of the touch screen 5, the software allows the user to select whether the plurality of coupons should be organized by the plurality of categories, by the list of merchants, or by the list of popular coupons. The process of organizing the plurality of coupons by the plurality of categories is shown in FIG. 8. The software is provided with a plurality of categories, which are pre-defined by the administrator of the software. The plurality of categories can change according the current location of the kiosk. For example, the plurality of categories can include more beach-related categories if the kiosk is located near the shore or can include more car-related categories if the kiosk is located near an autocross track. The software will organize the plurality of coupons into the plurality of categories with the pre-programmed computer 8 by comparing the product/service information of each coupon to the plurality of categories. For example, if the desired coupon is “buy one apple, get one apple free” and the plurality of categories includes sports, food, pets, etc., the software will organize the desired coupon into the food category. If the user chooses to view the plurality of coupons organized into the plurality of categories, then software will proceed to display the plurality of categories on the bottom section 7 of the touch screen 5, which allows the top section 6 of touch screen 5 to continuously display either the plurality of advertisements or the store directory in order to attract more customers to the kiosk. The software will then prompt the user to navigate through the plurality of categories with the bottom section 7 of the touch screen 5 in order to select the desired coupon. The user can more easily find a desired coupon by looking through the plurality of the categories. Once the user selects a chosen category from the plurality of categories, the software will prompt the user to choose one kind of the auxiliary coupon information with the bottom section 7 of the touch screen 5, which will be used to arrange the coupons within the chosen category. Thus, the software will optimally arrange the coupons within the chosen category with the pre-programmed computer 8 either by offer type, by discount degree, by date range, by location, or by rating. For example, if the user chooses discount degree as the means of arrangement, then the software will arrange the coupons within the chosen category by decreasing discount degree so that the coupons with a larger discount degree are more prominently shown on the touch screen 5 to the user. Another example is that if the user chooses location as the means of arrangement, then the software will arrange the coupons within the chosen category by the closest location so that coupons with a closer redeeming location are more prominently shown on the bottom section 7 of the touch screen 5.

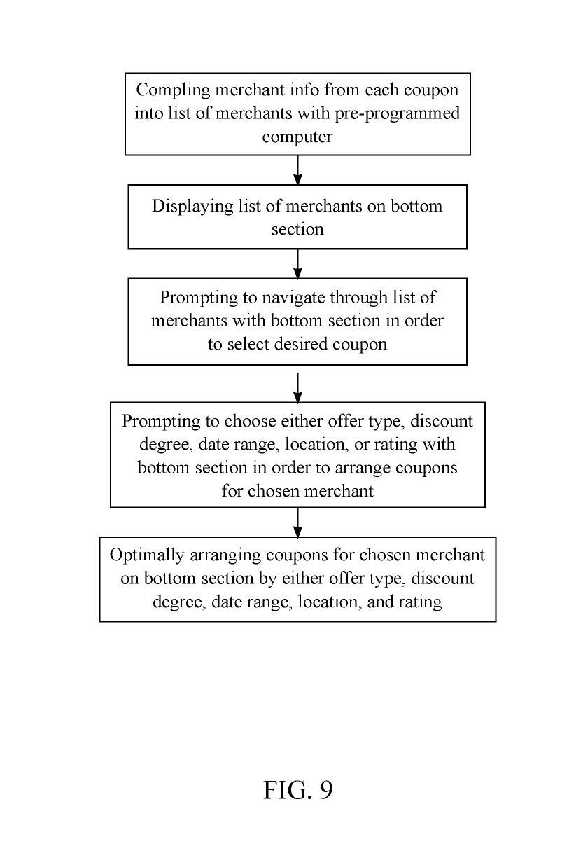

When the user chooses to have the plurality of coupons to be organized by a list of merchants, the software will compile the merchant information from each of the plurality of coupons in the list of merchants with the pre-programmed computer 8 so that the user can view a comprehensive list of all the merchants offering coupons. The process of organizing the plurality of coupons by the list of merchants is shown in FIG. 9. Similar to displaying the plurality of categories, the software will display the list of merchants on the bottom section 7 of the touch screen 5 so that the top section 6 of touch screen 5 can continue to display either the plurality of advertisements or the store directory in order to attract more customers to the kiosk. Also similar to displaying the plurality of categories, the software will prompt the user to navigate through the list of merchants with the bottom section 7 of the touch screen 5 in order to select the desired coupon. The user can more easily find a desired coupon by looking through the list of merchants. Once the user selects a chosen merchant from the list of merchants, the software will prompt the user to choose one kind of the auxiliary coupon information with the bottom section 7 of the touch screen 5, which will be used to arrange the coupons for the chosen merchant that are shown on the bottom section 7 of the touch screen 5. Thus, the software will optimally arrange the coupons for the chosen merchant on the bottom section 7 of the touch screen 5 either by offer type, by discount degree, by date range, by location, or by rating.

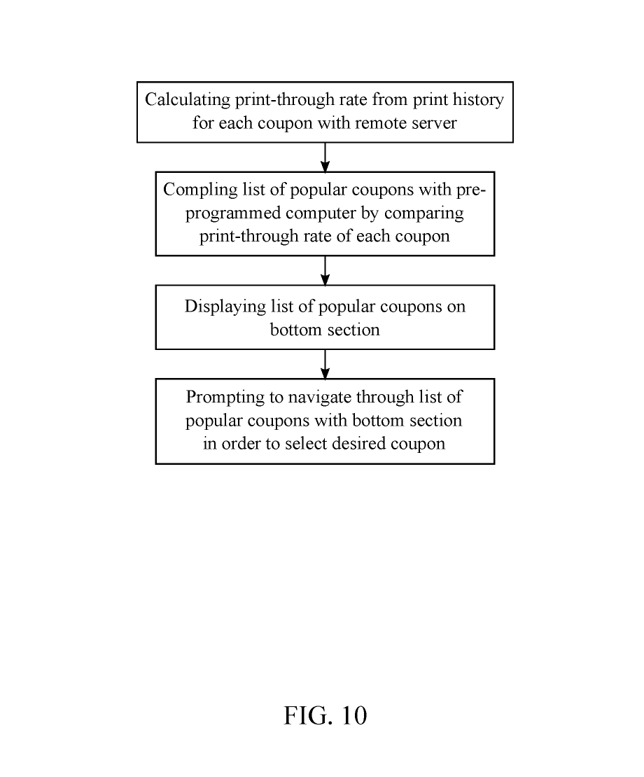

When the user chooses to have the plurality of coupons to be organized by a list of popular coupons, the software will compile the list of popular coupons with the pre-programmed computer 8 by comparing the print-through rate of each of the plurality of coupons so that the user can more easily view the most popular coupons. The process of organizing the plurality of coupons by the list of merchants is shown in FIG. 10. Similar to displaying the plurality of categories and the list of merchants, the software will display the list of popular coupons on the bottom section 7 of the touch screen 5 so that the top section 6 of touch screen 5 can continue to display either the plurality of advertisements or the store directory in order to attract more customers to the kiosk. Also similar to displaying the plurality of categories and the list of merchants, the software will prompt the user to navigate through the list of popular coupons with the bottom section 7 of the touch screen 5 in order to select the desired coupon.

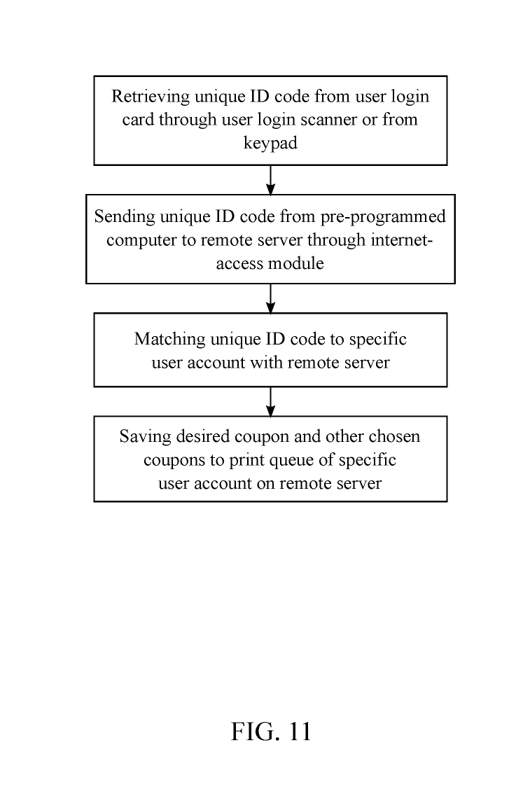

In addition, the software can provide the user to have a user account, which allows the software to save information that specifically related to that particular user, which is a process shown in FIG. 11. Each user account has a unique identification code, which is retrieved by the software when the user swipes and scans their user login card 16 on the user login receiver 3 or when the user enters the necessary information for the unique identification code through the keypad 1. Once the software retrieves a unique identification code, the pre-programmed computer 8 sends the unique identification code to the remote server 100 through the internet-access module 9. The software will then match that unique identification code to a specific user account and allows the user to access the information included in that specific user account such as a print queue and a plurality of subscription coupons, which are stored on the remote server 100. The print queue is a list of coupons that a particular user would save for future printing. Thus, the software will allow the user to save the desired coupon and other chosen coupons to the print queue of a specific user account on the remote server 100. This allows the user to access their print queue from any one of the dual screen kiosks communicating with the remote server 100.

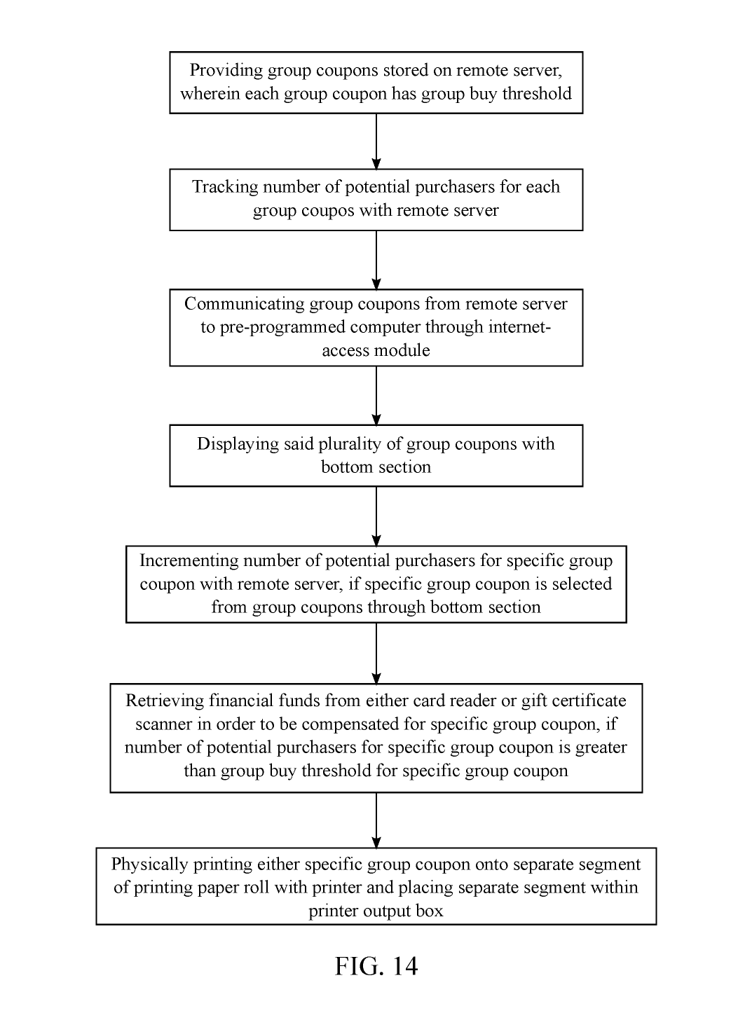

In addition, the software will provide a plurality of group coupons, which are coupons that can only be obtained by a group of users instead of just an individual user. As can be seen in FIG. 14, the plurality of group coupons is stored on the remote server 100 so that the remote server 100 can manage a group buy threshold for each of the plurality of group coupons. The group buy threshold is a designated number of users that need to place a claim on a group coupon before that group coupon becomes available for those users. In order to determine if any one of the plurality of group coupon reaches their group buy threshold, the remote server 100 tracks a number of potential purchasers for each of the plurality of group coupons. The number of potential purchasers is how many users have currently placed a claim on a group coupon. The software can only provide access to the plurality of group coupons if the user is logged onto their specific user account because the software needs to able to specifically identify each individual user through their user account in order to verify that a group coupon is being obtained by a group of users. Thus, the remote server 100 communicates the plurality of group coupons to the pre-programmed 8 through the internet-access module 9, which allows the plurality of group coupons to be displayed on the bottom section 7 of the touch screen 5. The remote server 100 increments the number of potential purchasers for a specific group coupon when a user selects the specific group coupon from the plurality of group coupons through the bottom section 7 of the touch screen 5. Moreover, if the number of potential purchasers for the specific group coupon becomes greater than the group buy threshold for the specific group coupon, then the dual screen kiosk will retrieve the financial funds from either the card reader 2 or the gift certificate scanner 4 in order to be compensated for the specific group coupon. This allows the specific group coupon to be printed onto a separate segment of the printing paper roll with the printer 11 and to be placed the separate segment within the printer output box 12.

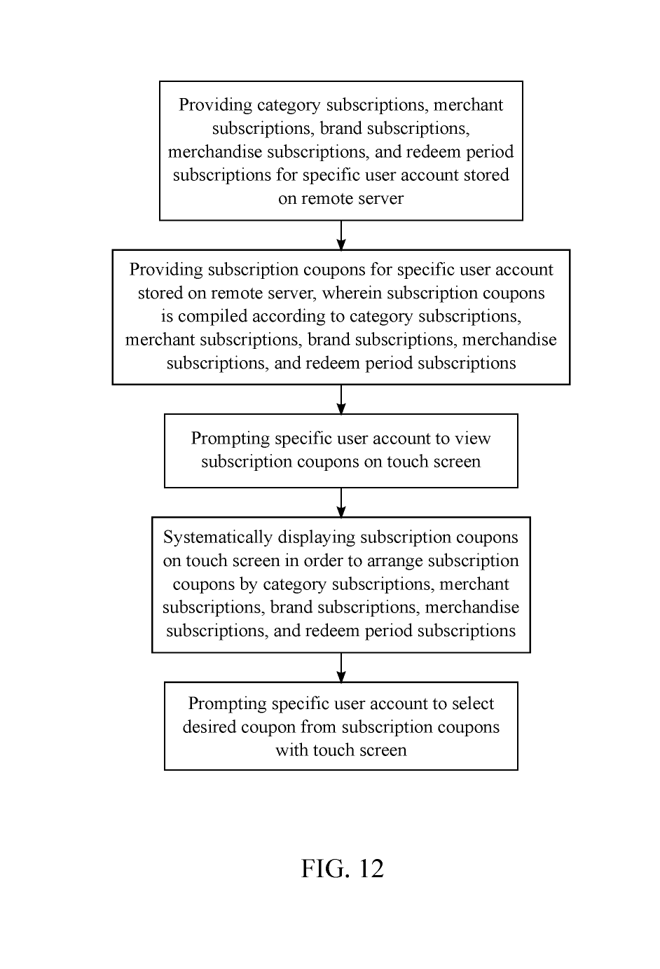

As can be seen in FIG. 12, each user account is also provided with category subscriptions, merchant subscriptions, brand subscriptions, merchandise subscriptions, and redeem period subscriptions, which are stored on the remote server 100. A category subscription is when a user agrees to receive coupons that relate to a particular category. For example, a user could have a coupon subscription for sports equipment, and that user would receive coupons from different sports equipment stores. A merchant subscription is when a user agrees to receive coupons that relate to particular merchant stores or particular retail locations. For example, a user could have coupon subscriptions for all “McDonald's in SOMA district of San Francisco,” and that user would receive coupons for different products/services from all “McDonald's in SOMA district of San Francisco.” A brand subscription is when a user agrees to receive coupons that relate to a particular brand. For example, a user could have a coupon subscription for “Levi's” brand of products/services and that user would receive coupons for any “Levi's” brand of products/services from any merchant store on any product/service category. A merchandise subscription is when a user agrees to receive coupons that relates to a particular product/service. For example, a user could have a coupon subscription for pants, and that user would specifically receive coupons for pants from any merchant store or any brand. A redeem period subscription is when a user agrees to receive coupons that are valid at least one time during a particular redeem period, which is specified or chosen by the user. For example, a user could have a coupon subscription for products/services that are available at a bargain during a redeem period between August 25^{th} and September 9^{th}. If an available coupon is valid between September 8^{th} and December 12^{th}, then the user would receive that available coupon because it is valid and can be redeemed for products/services between September 8^{th} and September 9^{th}. The category subscription, the merchant subscription, the brand subscription, and the redeem period subscription can be used in combination. For example, a user could combine a coupon subscription that is between August 25^{th} and September 9^{th} and that relates to “McDonald's”, and that user would receive coupons for “McDonald's” that are valid sometime between August 25^{th} and September 9^{th}.

The server or the central system compiles a list of subscription coupons by searching through the plurality of coupons in order to find coupons that match their category subscriptions, their merchant subscriptions, their brand subscriptions, their merchandise subscriptions, or their redeem period subscriptions. Thus, the software running on the pre-programmed computer 8 is provided with a plurality of subscription coupons for each user account by the remote server or the central system 100. Once a user logs into their specific user account, the software will prompt the specific user account to view their plurality of subscription coupons with the touch screen 5. When the specific user account chooses to view their plurality of subscription coupons, the software will systematically display their plurality of subscription coupons on the touch screen 5 based on their category subscriptions, their merchant subscriptions, their brand subscriptions, their merchandise subscriptions, and their time period subscriptions. The software will then prompt the specific user account to select a desired coupon from the plurality of subscription coupons with the touch screen 5.

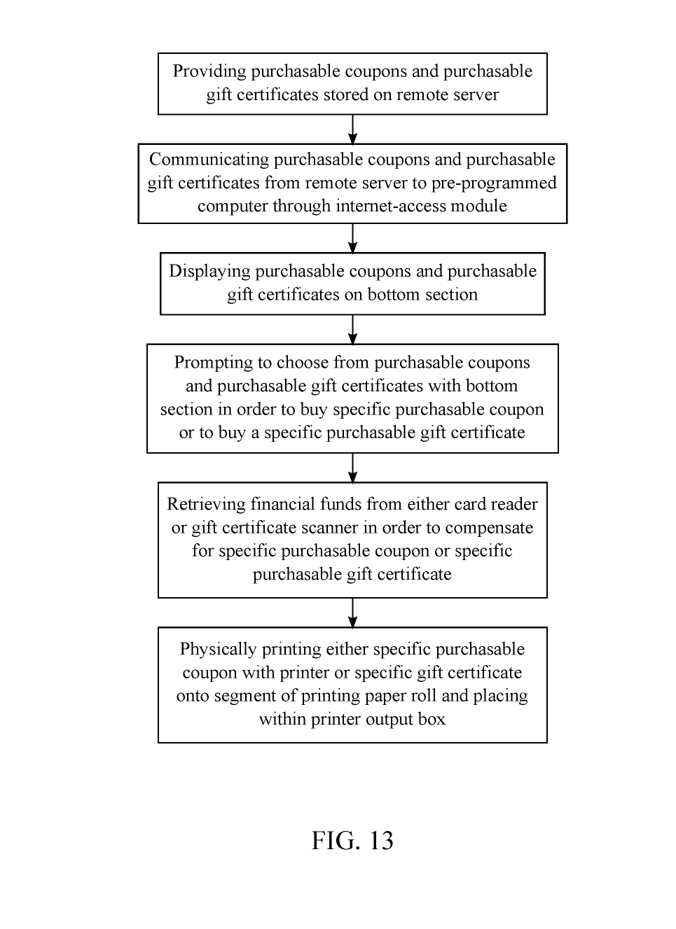

The software also allows the user to access a plurality of purchasable coupons and a plurality of purchasable gift certificates that part of the process shown in FIG. 13. Both the purchasable coupons and the purchasable gift certificates are stored on the remote server 100 so that the remote server 100 can manage the inventory of purchasable coupons and purchasable gift certificates. Thus, the remote server 100 also needs to communicate the plurality of purchasable coupons and the plurality of purchasable gift certificates, which allows the user of the dual screen kiosk to view and access the plurality of purchasable coupons and the plurality of purchasable gift certificates. A purchasable coupon is a kind of coupon, wherein the user has to meet certain criteria in order to receive the extra benefits of the coupon. For example, a purchasable coupon could be bought at a price of $4.00 and could offer $20.00 off of a $50.00 product/service before the purchasable coupon's expiration date. In this example, the user could buy the purchasable coupon, receive $20.00 off of a $50.00 product/service, and gain a $16.00 benefit. Conversely for this example, the user could buy the purchasable coupon and not receive $20.00 off if the product/service is less than $50.00 or if the purchasable coupon is redeemed after its expiration date. The user needs to purchase one of purchasable coupons from the software so that the user can acquire a physical copy of that purchasable coupon. In order to obtain a purchasable coupon, the software will begin by displaying the plurality of purchasable coupons on the bottom section 7 of the touch screen 5 and will prompt the user to choose from the plurality of purchasable coupons with the bottom section 7 of the touch screen 5 in order to buy a specific purchasable coupon from the plurality of purchasable coupons. The software will continue by retrieving financial funds from the user through either the card reader 2 or the gift certificate scanner 4 in order to be compensated for the specific purchasable coupon. Once the specific purchasable coupon is paid for by the user, the software will physically print the specific purchasable coupon onto a segment of printing paper roll 10 with the printer 11 and will place the segment within the printer output box 12.

A purchasable gift certificate provides funds for a particular merchant, wherein the funds can be purchased at full price or at a discounted price. As opposed to the purchasable coupon, the purchasable gift certificate does not impose any criteria or conditions that the user needs to meet in order to use the funds for the particular merchant. An example of a purchasable gift certificate with discounted funds is a $40.00 dining certificate for $20.00. An example of a combination between a purchasable coupon and a gift certificate is a $40.00 dining certificate for $20.00, which has conditions that include valid for a party of four people, invalid on Friday's, and invalid after its expiration date. Similar to the purchasable coupon, the user also needs to purchase one of the purchasable gift certificates from the software so that the user can acquire a physical copy of that purchasable gift certificate. In order to obtain a purchasable gift certificate, the software will begin by displaying the plurality of purchasable gift certificates on the bottom section 7 of the touch screen 5 and will prompt the user to choose from the plurality of purchasable gift certificates with the bottom section 7 of the touch screen 5 in order to buy a specific purchasable gift certificate from the plurality of purchasable gift certificates. The software will continue by retrieving financial funds from the user through either the card reader 2 or the gift certificate scanner 4 in order to be compensated for the specific purchasable gift certificate. In this case, the gift certificate scanner 4 will allow the software to exchange one gift certificate for another gift certificate. Once the specific purchasable gift certificate is paid for by the user, the software will physically print the specific purchasable gift certificate onto a segment of printing paper roll 10 with the printer 11 and will place the segment within the printer output box 12.

Although the invention has been explained in relation to its preferred embodiment, it is to be understood that many other possible modifications and variations can be made without departing from the spirit and scope of the invention as hereinafter claimed.

What is claimed is:

1. A method of navigating a coupon-dispensing graphic interface for a dual-screen kiosk, the method comprises the steps of:
providing a dual screen kiosk and at least one remote server, wherein said dual screen kiosk includes a pre-programmed computer, an internet-access module, a touch screen, a printer, and a printer output box;
providing a plurality of coupons stored on said remote server, wherein each of said plurality of coupons includes merchant information, product/service information, auxiliary coupon information, a print history, and a two-dimensional bar code;
providing a plurality of advertisements stored on said pre-programmed computer, wherein each of said plurality of advertisements is associated with a corresponding coupon from said plurality of coupons;
communicating said plurality of coupons from said remote server to said pre-programmed computer through said internet-access module;
cyclically and prominently displaying each of said plurality of advertisements on a top section of said touch screen;
systematically displaying said plurality of coupons on said bottom section, wherein said plurality of coupons is organized into a plurality of categories, a list of merchants, or a list of popular coupons;
sorting said plurality of coupons by said auxiliary coupon information with said pre-programmed computer, wherein said auxiliary coupon information includes offer type, discount degree, date range, valid locations, and reviews;
prompting to browse through said plurality of coupons with said bottom section;
prompting to select a desired coupon from said plurality of coupons through said bottom section or through said plurality of advertisements on said top section;
displaying said merchant information, said product/service information, said auxiliary coupon information, and said two-dimensional bar code of said desired coupon on said bottom section;
physically printing said desired coupon onto a segment of a printing paper roll with said printer and placing said segment within said printer output box; and
updating said print history of said desired coupon with said remote server,
if said desired coupon is physically printed on said segment of printing paper roll or if desired coupon is retrieved by a mobile computing device through said two-dimensional bar code.

2. The method of navigating a coupon-dispensing graphic interface for a dual-screen kiosk, the method as claimed in claim 1 comprises the steps of:
organizing said plurality of coupons into said plurality of categories with said pre-programmed computer by comparing said product/service information to said plurality of categories;
displaying said plurality of categories on said bottom section; and
prompting to navigate through said plurality of categories with said bottom section in order to select said desired coupon.

3. The method of navigating a coupon-dispensing graphic interface for a dual-screen kiosk, the method as claimed in claim 2 comprises the steps of:
prompting to choose either said offer type, said discount degree, said date range, said location, or said rating with said bottom section in order to arrange said plurality of coupons within a chosen category from said plurality of categories;
optimally arranging said plurality of coupons within said chosen category with said pre-programmed computer by either said offer type, said discount degree, said date range, said location, or said rating; and
prominently displaying each of said plurality of coupons within said chosen category with respect to a current kiosk location on said touch screen,
if said location is chosen to optimally arrange said plurality of coupons.

4. The method of navigating a coupon-dispensing graphic interface for a dual-screen kiosk, the method as claimed in claim 1 comprises the steps of:
compiling said merchant information from each of said plurality of coupons into said list of merchants with said pre-programmed computer;
displaying said list of merchants on said bottom section; and
prompting to navigate through said list of merchants with said bottom section in order to select said desired coupon.

5. The method of navigating a coupon-dispensing graphic interface for a dual-screen kiosk, the method as claimed in claim 4 comprises the steps of:
prompting to choose either said offer type, said discount degree, said date range, said location, or said rating with said bottom section in order to arrange said plurality of coupons for a chosen merchant from said list of merchants; and
optimally arranging said plurality of coupons for said chosen merchant on said bottom section by either said offer type, said discount degree, said date range, said location, or said rating.

6. The method of navigating a coupon-dispensing graphic interface for a dual-screen kiosk, the method as claimed in claim 1 comprises the steps of:
calculating a print-through rate from said print history for each of said plurality of coupons with said remote server;
compiling said list of popular coupons with said pre-programmed computer by comparing said print-through rate of each of said plurality of coupons;
displaying said list of popular coupons on said bottom section; and
prompting to navigate through said list of popular coupons with said bottom section in order to select said desired coupon.

7. The method of navigating a coupon-dispensing graphic interface for a dual-screen kiosk, the method as claimed in claim 1 comprises the steps of:
providing said dual screen kiosk with a user login receiver or a keypad;
retrieving a unique identification code from a user login card through said user login receiver or retrieving said unique identification code from said keypad;
sending said unique identification code from said pre-programmed computer to said remote server through said internet-access module;
matching said unique identification code to a specific user account with said remote server; and
saving said desired coupon and other chosen coupons to a print queue of said specific user account on said remote server, wherein other chosen coupons are from said plurality of coupons.

8. The method of navigating a coupon-dispensing graphic interface for a dual-screen kiosk, the method as claimed in claim 7 comprises the steps of:
providing category subscriptions, merchant subscriptions, brand subscriptions, merchandise subscriptions, and redeem period subscriptions for said specific user account stored on said remote server;
providing a plurality of subscription coupons for said specific user account stored on said remote server, wherein said plurality of subscriptions coupons is compiled according to said category subscriptions, said merchant subscriptions, said brand subscriptions, merchandise subscriptions, and said redeem period subscriptions;
prompting said specific user account to view said plurality of subscription coupons on said touch screen;
systematically displaying said plurality of subscription coupons on said touch screen in order to arrange said plurality of subscription coupons by said category subscriptions, said merchant subscriptions, said brand subscriptions, said merchandise subscriptions, and said redeem period subscriptions; and
prompting said specific user account to select said desired coupon from said plurality of subscription coupons with said touch screen.

9. The method of navigating a coupon-dispensing graphic interface for a dual-screen kiosk, the method as claimed in claim 1 comprises the steps of:
providing said dual screen kiosk with a card reader and a gift certificate scanner;
providing a plurality of purchasable coupons and a plurality of purchasable gift certificates stored on said remote server;
communicating said plurality of purchasable coupons or said plurality of purchasable gift certificates from said remote server to said pre-programmed computer through said internet-access module;
displaying said plurality of purchasable coupons or said plurality of purchasable gift certificates on said bottom section;
prompting to choose from said plurality of purchasable coupons or from said plurality of purchasable gift certificates with said bottom section in order to buy a specific purchasable coupon from said plurality of purchasable coupons or a specific purchasable gift certificate from said plurality of purchasable gift certificates;
retrieving financial funds from either said card reader or said gift certificate scanner in order to be compensated for said specific purchasable coupon or said specific purchasable gift certificate; and
physically printing either said specific purchasable coupon or said specific purchasable gift certificate onto said segment of said printing paper roll with said printer and placing said segment within said printer output box.

10. The method of navigating a coupon-dispensing graphic interface for a dual-screen kiosk, the method as claimed in claim 1 comprises the steps of:
providing said dual screen kiosk with a card reader and a gift certificate scanner;
providing a plurality of group coupons stored on said remote server, wherein each of said plurality of group coupons has a group buy threshold;
tracking a number of potential purchasers for each of said plurality of group coupons with said remote server;
communicating said plurality of group coupons from said remote server to said pre-programmed computer through said internet-access module;
displaying said plurality of group coupons with said bottom section;
incrementing said number of potential purchasers for a specific group coupon with said remote server,
if said specific group coupon is selected from said plurality of group coupons through said bottom section;
retrieving financial funds from either said card reader or said gift certificate scanner in order to be compensated for said specific group coupon,
if said number of potential purchasers for said specific group coupon is greater than said group buy threshold for said specific group coupon; and
physically printing either said specific group coupon onto a separate segment of said printing paper roll with said printer and placing said separate segment within said printer output box.

11. A method of navigating a coupon-dispensing graphic interface for a dual-screen kiosk, the method comprises the steps of:
providing a dual screen kiosk and at least one remote server, wherein said dual screen kiosk includes a pre-programmed computer, an internet-access module, a touch screen, a printer, and a printer output box;
providing a plurality of coupons stored on said remote server, wherein each of said plurality of coupons includes merchant information, product/service information, auxiliary coupon information, print history, and a two-dimensional bar code;
providing a store directory stored on said remote server, wherein said store directory includes a plurality of store locations;
communicating said plurality of coupons and said store directory from said remote server to said pre-programmed computer through said internet-access module;
prominently displaying said store directory with each of said plurality of store locations on a top section of said touch screen;
prompting to select a specific store location from said store directory with said top section;
displaying a frontal picture of said specific store location and said plurality of coupons for said specific store location on a bottom section of said touch screen, if said specific store location is selected from said store directory;
prompting to view product/service-related store locations to said specific store location with said bottom section, if said specific store location is selected from said store directory;
systematically displaying said plurality of coupons on said bottom section, wherein said plurality of coupons is organized into a plurality of categories, a list of merchants, or a list of popular coupons;
sorting said plurality of coupons by said auxiliary coupon information with said pre-programmed computer, wherein said auxiliary coupon information includes offer type, discount degree, date range, location, and reviews;
prompting to browse through said plurality of coupons with said bottom section;
prompting to select a desired coupon from said plurality of coupons with said bottom section;
displaying said merchant information, said product/service information, said auxiliary coupon information, and said two-dimensional bar code of said desired coupon with said bottom section;
physically printing said desired coupon onto a segment of a printing paper roll with said printer and placing said segment within said printer output box; and
updating said print history of said desired coupon with said remote server,
if said desired coupon is physically printed on said segment of printing paper roll or if desired coupon is retrieved by a mobile computing device through said two-dimensional bar code.

12. The method of navigating a coupon-dispensing graphic interface for a dual-screen kiosk, the method as claimed in claim 11 comprises the steps of:
organizing said plurality of coupons into said plurality of categories with said pre-programmed computer by comparing said product/service information to said plurality of categories;
displaying said plurality of categories on said bottom section; and
prompting to navigate through said plurality of categories with said bottom section in order to select said desired coupon.

13. The method of navigating a coupon-dispensing graphic interface for a dual-screen kiosk, the method as claimed in claim 12 comprises the steps of:
prompting to choose either said offer type, said discount degree, said date range, said location, or said rating with said bottom section in order to arrange said plurality of coupons within a chosen category from said plurality of categories;
optimally arranging said plurality of coupons within said chosen category with said pre-programmed computer by either said offer type, said discount degree, said date range, said location, or said rating; and
prominently displaying each of said plurality of coupons within said chosen category with respect to a current kiosk location on said touch screen,
if said location is chosen to optimally arrange said plurality of coupons.

14. The method of navigating a coupon-dispensing graphic interface for a dual-screen kiosk, the method as claimed in claim 11 comprises the steps of:
compiling said merchant information from each of said plurality of coupons into said list of merchants with said pre-programmed computer;
displaying said list of merchants on said bottom section; and
prompting to navigate through said list of merchants with said bottom section in order to select said desired coupon.

15. The method of navigating a coupon-dispensing graphic interface for a dual-screen kiosk, the method as claimed in claim 14 comprises the steps of:
prompting to choose either said offer type, said discount degree, said date range, said location, or said rating with said bottom section in order to arrange said plurality of coupons for a chosen merchant from said list of merchants; and
optimally arranging said plurality of coupons for said chosen merchant on said bottom section by either said offer type, said discount degree, said date range, said location, or said rating.

16. The method of navigating a coupon-dispensing graphic interface for a dual-screen kiosk, the method as claimed in claim 11 comprises the steps of:
calculating a print-through rate from said print history for each of said plurality of coupons with said remote server;
compiling said list of popular coupons with said pre-programmed computer by comparing said print-through rate of each of said plurality of coupons;
displaying said list of popular coupons on said bottom section; and
prompting to navigate through said list of popular coupons with said bottom section in order to select said desired coupon.

17. The method of navigating a coupon-dispensing graphic interface for a dual-screen kiosk, the method as claimed in claim 11 comprises the steps of:
providing said dual screen kiosk with a user login receiver or a keypad;
retrieving a unique identification code from a user login card through said user login receiver or retrieving said unique identification code from said keypad;
sending said unique identification code from said pre-programmed computer to said remote server through said internet-access module;
matching said unique identification code to a specific user account with said remote server; and
saving said desired coupon and other chosen coupons to a print queue of said specific user account on said remote server, wherein other chosen coupons are from said plurality of coupons.

18. The method of navigating a coupon-dispensing graphic interface for a dual-screen kiosk, the method as claimed in claim 17 comprises the steps of:
providing category subscriptions, merchant subscriptions, brand subscriptions, merchandise subscriptions, and redeem period subscriptions for said specific user account stored on said remote server;
providing a plurality of subscription coupons for said specific user account stored on said remote server, wherein said plurality of subscriptions coupons is compiled according to said category subscriptions, said merchant subscriptions, said brand subscriptions, merchandise subscriptions, and said redeem period subscriptions;
prompting said specific user account to view said plurality of subscription coupons on said touch screen;
systematically displaying said plurality of subscription coupons on said touch screen in order to arrange said plurality of subscription coupons by said category subscriptions, said merchant subscriptions, said brand subscriptions, said merchandise subscriptions, and said redeem period subscriptions; and
prompting said specific user account to select said desired coupon from said plurality of subscription coupons with said touch screen.

19. The method of navigating a coupon-dispensing graphic interface for a dual-screen kiosk, the method as claimed in claim 11 comprises the steps of:
providing said dual screen kiosk with a card reader and a gift certificate scanner;
providing a plurality of purchasable coupons and a plurality of purchasable gift certificates stored on said remote server;
communicating said plurality of purchasable coupons or said plurality of purchasable gift certificates from said remote server to said pre-programmed computer through said internet-access module;
displaying said plurality of purchasable coupons or said plurality of purchasable gift certificates on said bottom section;
prompting to choose from said plurality of purchasable coupons or from said plurality of purchasable gift certificates with said bottom section in order to buy a specific purchasable coupon from said plurality of purchasable coupons or a specific purchasable gift certificate from said plurality of purchasable gift certificates;
retrieving financial funds from either said card reader or said gift certificate scanner in order to be compensated for said specific purchasable coupon or said specific purchasable gift certificate; and
physically printing either said specific purchasable coupon or said specific purchasable gift certificate onto said segment of said printing paper roll with said printer and placing said segment within said printer output box.

20. The method of navigating a coupon-dispensing graphic interface for a dual-screen kiosk, the method as claimed in claim 11 comprises the steps of:
providing said dual screen kiosk with a card reader and a gift certificate scanner;
providing a plurality of group coupons stored on said remote server, wherein each of said plurality of group coupons has a group buy threshold;
tracking a number of potential purchasers for each of said plurality of group coupons with said remote server;
communicating said plurality of group coupons from said remote server to said pre-programmed computer through said internet-access module;
displaying said plurality of group coupons with said bottom section;
incrementing said number of potential purchasers for a specific group coupon with said remote server,
if said specific group coupon is selected from said plurality of group coupons through said bottom section;
retrieving financial funds from either said card reader or said gift certificate scanner in order to be compensated for said specific group coupon,
if said number of potential purchasers for said specific group coupon is greater than said group buy threshold for said specific group coupon; and
physically printing either said specific group coupon onto a separate segment of said printing paper roll with said printer and placing said separate segment within said printer output box.
